(19) United States
(12) Patent Application Publication
(10) Pub. No.: US 2008/0034150 A1
(43) Pub. Date: Feb. 7, 2008

(54) Data processing circuit

(75) Inventor: Naoki Mitsuishi, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/879,499

(22) Filed: Jul. 18, 2007

(30) Foreign Application Priority Data
Aug. 2, 2006 (JP) 2006-210751

(51) Int. Cl. G06F 12/00

(52) U.S. Cl. 711/102

(57) ABSTRACT

The present invention realizes improvement in security in the case where a nonvolatile memory device which can be read/written by random access is mounted as a memory for storing both of a program and data. In a microcomputer including: a CPU enabling a computing process based on a preset program; and a nonvolatile memory device which can be read/written by random access of the CPU, the nonvolatile memory device includes, in a part of its memory area, an area in which nonvolatile holding is invalid. By using the area as an area for storing secret data to be held, the secret data to be held is prevented from being nonvolatile-held in the nonvolatile memory device. Thus, improvement in security is achieved.

### CROSS-REFERENCE TO RELATED APPLICATIONS

The disclosure of Japanese Patent Application No. 2006-210751 filed on Aug. 2, 2006 including the specification, drawings and abstract is incorporated herein by reference in its entirety.

### BACKGROUND OF THE INVENTION

The present invention relates to a microcomputer and a technique effectively used for a single-chip microcomputer formed on a single semiconductor substrate.

In a single-chip microcomputer, function blocks such as a central processing unit (CPU), a ROM (Read Only Memory) for holding programs, a RAM (Random Access Memory) for holding data, and an input/output circuit for inputting/outputting data are formed on a single semiconductor substrate. The case where a flash memory is provided as a ROM of such a single-chip microcomputer is increasing. Data of the flash memory is always rewritable, so that usability can improve. The flash memory is an electrically erasable programmable ROM. Due to its characteristics, the flash memory has to be rewritten after being erased once. It is possible to store a dedicated program for controlling writing and erasure in another memory and execute the program by a CPU (refer to, for example, Japanese Unexamined Patent Publication No. Sho 63 (1988)-266698). As described above, data cannot be continuously read/written from/to the flash memory in an arbitrary address order by a CPU, so that the flash memory cannot be accessed at random. For those reasons, the flash memory cannot be used as a work data area of the CPU. As a work data area, a RAM is necessary. However, the RAM is having problems of holding current, a soft error, and the like as a semiconductor integrated circuit is becoming finer. As a countermeasure against a soft error, the case where an error correction logic is provided is increasing. A technique of holding data upon shutdown of power by using a flash memory is known (refer to, for example, Japanese Unexamined Patent Publication No. 2005-322293). Since a flash memory has to be erased first and, after that, written and the writing and erasing takes time, to increase the speed of writing for the data holding, the flash memory is erased in advance. The preliminarily erasing operation is performed after confirming the data in the flash memory. In other words, erasing operation is performed as an initializing process in execution of a program.

On the other hand, as a memory which is a nonvolatile memory typified by a flash memory and, yet, can be unlimitedly read/written, a magneto-resistive random access memory (MRAM) is known (refer to, for example, Japanese Unexamined Patent Publication Nos. 2002-222589 and 2004-86986). An MRAM stores information by using the magneto-resistance effect in which resistance of an element varies according to the magnetization direction. By development of a magnetic tunnel junction (MTJ) device whose magnetic resistance change rate is higher than that of a conventional device, reading/writing operations as fast as those of a static random access memory (SRAM) can be performed, and packing density as high as that of a DRAM can be realized. By such an MRAM, like a conventional RAM, data can be read/written by random access. Moreover, it is unnecessary to erase the MRAM in advance at the time of writing.

### SUMMARY OF THE INVENTION

A RAM (NVRAM) capable of nonvolatile-holding data like an MRAM can be read/written at random, so that it can be used as a program area and a work data area of a CPU. Moreover, by storing data in the NVRAM, the stored data can be held also after power shutdown. Therefore, by mounting the NVRAM, at the time of power-on, reset, or the like, data before that can be referred to. Consequently, a memory for a program and a memory for work can be realized by a single NVRAM. When one kind of memory is sufficient, the hardware resources can be saved, and it can contribute to simplify the manufacturing process.

When the inventors of the present invention examined mounting of such a NVRAM on a microcomputer, however, it was found that retention of all of data in an NVRAM built in a microcomputer is unpreferable from the viewpoint of security. For example, when secret information such as ID information, key information, and decrypted information which was encrypted is nonvolatile-held, there may be a case such that the microcomputer is operated maliciously to read secret information.

An object of the present invention is to provide a technique for achieving improvement in security in the case where a nonvolatile memory device (NVRAM) which can be read/written at random access is mounted as a memory for storing a program and data.

The above and other objects and novel advantages of the present invention will become apparent from the description of the specification and the appended drawings.

Outline of representative ones of the inventions disclosed in the specification will be briefly described as follows.

(1) In a microcomputer including: a CPU enabling a computing process based on a preset program; and a nonvolatile memory device which can be read/written by random access of the CPU, the nonvolatile memory device includes, in a part of its memory area, an area in which nonvolatile holding is invalid.

With the means, the nonvolatile memory device includes, in a part of its memory area, an area in which nonvolatile holding is invalid. Consequently, by using this area as an area for storing secret data to be held, the secret data to be held can be prevented from being nonvolatile-held in the nonvolatile memory device. It realizes improvement in security in the case where the nonvolatile memory device which can be read/written by random access is mounted as a memory for programs and data.

### (2) In the microcomputer (1), information stored in the nonvolatile memory device can be rewritten without a preliminary erasing process at the time of the writing operation.

(3) The microcomputer (1) may further include a power detector capable of detecting a power voltage level. After power-on, operation of the nonvolatile memory device is started on the basis of a detection result of the power detector.

### (4) The microcomputer (1) may further include an operation monitor for monitoring operation of the CPU. The operation of the nonvolatile memory device is started on the basis of a result of monitoring in the operation monitor.

(5) In the microcomputer (1), the nonvolatile memory device may include a program area capable of storing a program to be executed by the CPU and a data area capable of storing data used in the execution of the program in the CPU. By execution of the program in the CPU, data writing to the data area is enabled and, after invalidating nonvolatile holding in at least a part of the memory area in the nonvolatile memory device, reading operation of the CPU is permitted.

### (6) In the microcomputer (1), the operation of invalidating nonvolatile holding in at least a part of the memory area in the nonvolatile memory device may be an operation of writing data to the nonvolatile memory device.

(7) In the microcomputer (1), the nonvolatile memory device may include a program area capable of storing a program to be executed by the CPU and a data area capable of storing data used in the execution of the program in the CPU. By execution of the program in the CPU, data writing to the data area is enabled and, after writing data to the data area by the CPU, reading of the data area is permitted.
(8) In the microcomputer (1), the nonvolatile memory device may be disposed in each of a first address area and a second address area managed by the CPU. Only reading of the nonvolatile memory device is allowed from the first address area, and reading and writing of the nonvolatile memory device is allowed from the second address area.

### (9) In the microcomputer (1), secret data to be held may be stored in the area in which nonvolatile holding is invalid in the nonvolatile memory device.

### (10) In the microcomputer (1), original data to be encrypted, decrypted data, or information for encryption or decryption may be stored in the area in which nonvolatile holding is invalid in the nonvolatile memory device.

(11) In the microcomputer (6), writing operation for invalidating nonvolatile holding in at least a part of the memory area in the nonvolatile memory device may be performed separately from writing operation performed by executing a program in the CPU.
(12) A microcomputer may be constructed by: a CPU enabling a computing process based on a preset program; a nonvolatile memory device which can be read/written by random access of the CPU; and a memory controller for invalidating nonvolatile holding in a part of a memory area in the nonvolatile memory device at the time of at least one of operation start and power shutdown of the nonvolatile memory device.

In such a configuration as well, since the nonvolatile memory device includes, in a part of its memory area, an area in which nonvolatile holding is invalid, by using this area as an area for storing secret data to be held, the secret data to be held can be prevented from being nonvolatile-held in the nonvolatile memory device. It realizes improvement in security in the case where the nonvolatile memory device which can be read/written by random access is mounted as a memory for programs and data.

### (13) In the microcomputer (12), information stored in the nonvolatile memory device can be rewritten without a preliminary erasing process at the time of the writing operation.

(14) The microcomputer (12) may further include a reset controller capable of generating a reset signal for resetting the CPU and the nonvolatile memory device to an initial state and to start operation. The reset controller includes a power detector for detecting level of power voltage supplied to the microcomputer, and generates the reset signal on the basis of a result of detection in the power detector.
(15) The microcomputer (12) may further include a reset controller capable of generating a reset signal for resetting the nonvolatile memory device to an initial state and to start operation, and an operation monitor capable of monitoring operation of the CPU. The reset controller generates the reset signal on the basis of a result of monitoring in the operation monitor.
(16) In the microcomputer (12), the nonvolatile memory device may include a program area capable of storing a program to be executed by the CPU and a data area capable of storing data used in the execution of the program in the CPU. By execution of the program in the CPU, data writing to the data area is enabled and, after invalidating nonvolatile holding in at least a part of the memory area in the nonvolatile memory device, reading operation of the CPU is permitted.
(17) In the microcomputer (12), the nonvolatile memory device may include a program area capable of storing a program to be executed by the CPU and a data area capable of storing data used in the execution of the program in the CPU. After data is written to the data area by the CPU, operation of reading the data area is permitted.

### (18) In the microcomputer (12), an area in which nonvolatile holding is invalid in the nonvolatile memory device may be a work area which does not include an exception process vector of the CPU.

### (19) In the microcomputer (12), the CPU may store secret data to be held in the area in which nonvolatile holding is invalid in the nonvolatile memory device.

(20) In the microcomputer (12), the memory controller may include a write control unit for generating a signal for making nonvolatile holding invalid and a multiplexer for selecting a signal for making the nonvolatile holding invalid and a signal for reading or writing of the CPU.
(21) In the microcomputer (12), the memory controller may include a write control unit for performing a writing operation for invalidating nonvolatile holding in at least a part of the memory area in the nonvolatile memory device separately from writing operation performed by the CPU.
(22) A microcomputer may include: a CPU enabling a computing process based on a preset program; and a nonvolatile memory device which can be read/written by random access of the CPU. The nonvolatile memory device includes a program area capable of storing a program to be executed by the CPU and a data area capable of storing data used in the execution of the program in the CPU. The data area includes a first memory area in which nonvolatile holding is valid and a second memory area in which nonvolatile holding is invalid, and the CPU uses the second memory area as a work area.

With the means, the nonvolatile memory device includes the second memory area in which nonvolatile holding is invalid. By using the area as the work area of the CPU, for example, even in the case where power is shut down maliciously during operation of the CPU, nonvolatile holding in the second memory area is made invalid. Consequently, data in a work in the CPU can be prevented from being read from the outside. It realizes enhancement in security.

(23) In the microcomputer (22), operation of writing or rewriting the area in which nonvolatile holding is invalid in the nonvolatile memory device may be performed at the time of at least one of operation start and power shutdown of the nonvolatile memory device.

### (24) In the microcomputer (22), reading from the nonvolatile memory device may be interrupted until the area in which nonvolatile holding is invalid in the nonvolatile memory device is written or rewritten.

The effects obtained by the representative ones of the inventions disclosed in the specification will be briefly described as follows.

The security in the case where a nonvolatile memory device (NVRAM) which can be read/written by random access is mounted as a memory for programs and data can be improved.

### BRIEF DESCRIPTION OF THE DRAWINGS

FIG. 1 is a block diagram showing a configuration example of a microcomputer as an embodiment of the present invention.

FIG. 2 is a block diagram showing another configuration example of the microcomputer.

FIG. 3 is a block diagram showing a configuration example of an NVMC included in the microcomputer.

FIG. 4 is a block diagram showing another configuration example of the NVMC included in the microcomputer.

FIGS. 5A and 5B are diagrams illustrating an address space managed by a CPU included in the microcomputer.

FIG. 6 is a diagram illustrating an example of data stored in an NVRAM included in the microcomputer.

FIG. 7 is a diagram showing state transition of the NVMC included in the microcomputer.

FIG. 8 is a diagram showing another state transition of the NVMC included in the microcomputer.

FIG. 9 is an operation timing chart of main parts in the microcomputer.

FIG. 10 is another operation timing chart of the main parts in the microcomputer.

FIG. 11 is another operation timing chart of the main parts in the microcomputer.

FIG. 12 is an operation timing chart of the microcomputer in the case of employing the configuration of FIG. 4.

FIG. 13 is a flowchart at the time of cancelling reset of the CPU included in the microcomputer.

FIG. 14 is a diagram showing an application example of the microcomputer.

FIG. 15 is a flowchart of processes in the application example shown in FIG. 14.

### DETAILED DESCRIPTION OF THE PREFERRED EMBODIMENTS

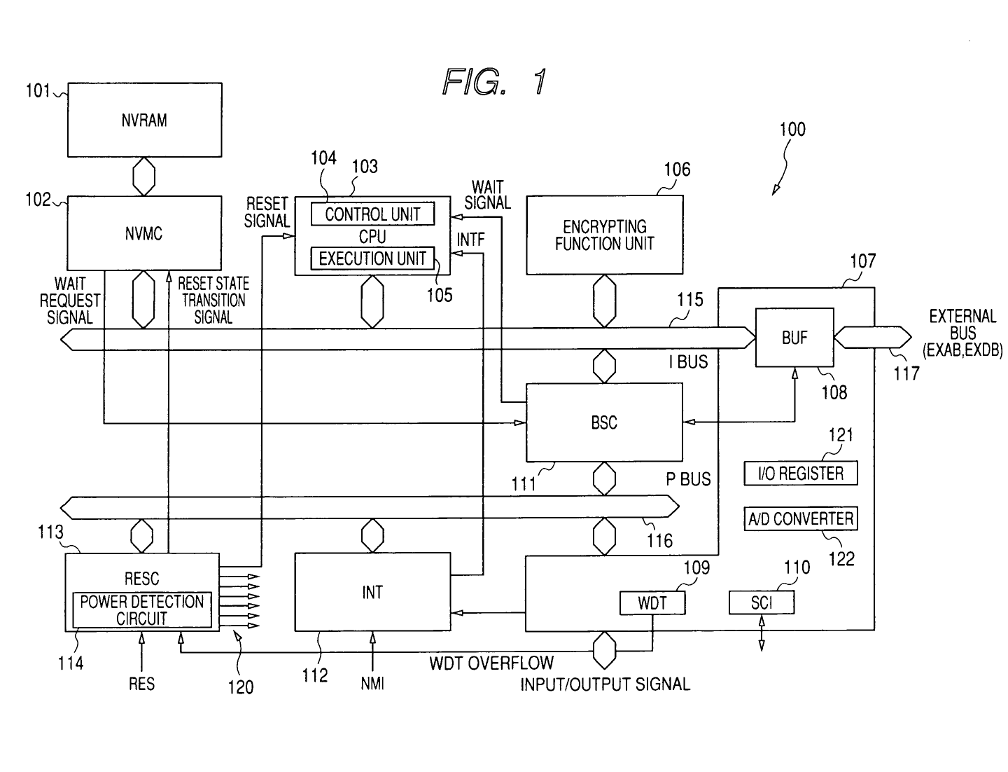

FIG. 1 shows a configuration example of a microcomputer according to the present invention.

A microcomputer 100 is a single-chip microcomputer and includes, although not limited, a central processing unit (CPU) 103, a nonvolatile memory device (NVRAM) 101, a memory controller (NVMC) 102, a bus controller (BSC) 111, a reset controller (RESC) 113, an interrupt controller (INT) 112, an encrypting function unit 106, and an input/output (I/O) unit 107. The microcomputer 100 is formed on a single semiconductor substrate such as a single crystal silicon substrate by the known semiconductor integrated circuit manufacturing technique.

The I/O unit 107 includes not only input/output ports to/from which various signals can be input/output from/to the outside but also various peripheral circuits such as a buffer (BUF) 108 interposed between an internal bus (I bus) and external buses (EXAB and EXDB), a watchdog timer (WDT) 109 for watching the operation of the CPU 103, a serial communication interface (SCI) 110 enabling serial communication via a serial communication line, and an A/D (Analog/Digital) converter 122 for converting an analog signal to a digital signal.

Although not shown, the microcomputer 100 is provided with function blocks such as a clock oscillator (CPG).

The CPU 103 includes a control unit 104 and an execution unit 105 and, mainly, executes an instruction fetched from the NVRAM 101. As a data area for work, the NVRAM 101 is used.

The NVRAM 101 is, although not limited, a magnetoresistive random access memory (MRAM) as an example of a memory which is a nonvolatile memory and, yet, can be unlimitedly read/written. In the MRAM, a plurality of memory cells capable of storing information by using the magnetoresistive effect in which resistance of an element varies according to the magnetization direction are disposed in an array. The memory cell is a magnetic tunnel junction (MTJ) element or the like. The operation of the NVRAM 101 is controlled by the NVMC 102. The NVRAM 101 is coupled to an I bus 115 via the NVMC 102 and reading/writing operation can be performed via the I bus 115. The NVMC 102 can write data to a predetermined address, generates a control signal for the writing, an address signal, and data, multiplexes the signals with corresponding signals sent via the I bus 115, and sends the resultant signals to the NVRAM 101. That is, data can be written to the VRAM 101 both from the I bus 115 and the NVMC 102. The NVMC 102 generates a wait signal and supplies it to the BSC 111 as necessary.

The microcomputer 100 has an I bus (first internal bus) 115 and a P bus (second internal bus) 116. Via the buses, the function blocks are coupled to each other. Each of the buses includes an address bus, a data bus and, in addition, a control bus for transmitting a bus right request signal, a bus acknowledge signal, bus commands (or a read signal, a write signal, and a bus size signal), a ready signal (or wait signal), and the like.

The I bus 115 enables high-speed access to the NVRAM 101 by the CPU 103. The NVRAM 101 is accessed in one state. Since the number of parts to be coupled to is small, the bus width can be arbitrarily set to, for example, 32 bits. In the case of providing an internal bus master such as a DMAC (Direct Memory Access Controller), the bus master is coupled to the I bus.

The encrypting function unit 106 is coupled to the I bus 115 and performs an encrypting process and a decrypting process under control of the CPU 103. The encrypting function unit 106 may be a bus master or a bus slave. In the case where the encrypting function unit 106 functions as a bus master, the encrypting function unit 106 reads/writes data from/to the NVRAM 101. The encrypting function unit 106 can execute an encrypting process using key information stored in a nonvolatile holding invalid area.

To the P bus 116, an I/O register 121 included in the I/O unit 107, the peripheral circuits, and the like are coupled. Since the I bus 115 and the P bus 116 are separated from each other, by program reading operation of the CPU 103 and the like, the load on the I bus mainly used can be lessened, so that the processing speed can be increased. By maintaining the state of the P bus 116 in an unused state, the power consumption can be lowered.

In the case where the CPU 103 accesses the I/O register 121 coupled to the P bus 116, an access is made via the I bus 115 and the BSC 111. The I/O register 121 is accessed in two states. Since the number of parts connected is large, if the bus width is increased, the physical scale increases. Therefore, the bus width is set to, for example, 16 bits.

The I bus 115 and the external bus 117 are interfaced by the buffer (BUF) 108. To the external bus 117, an external memory and the like can be coupled. The buses are controlled by the bus controller (BSC). A wait request is sent from the NVMC 102 and the BUF 108 to the BSC 111. The BSC 111 can send a wait request to the CPU 103.

The reset controller (RESC) 113 fetches a reset factor such as a reset signal RES input from the outside of the microcomputer 100, and outputs a reset signal 120 to the modules of the microcomputer 100. The reset signal 120 includes a reset signal supplied to the CPU 103 and a reset state transition signal supplied to the NVMC 102. The reset factor includes an overflow of the WDT 109. The RESC 113 includes a power detection circuit 114 for detecting a power supply voltage Vcc level and, on the basis of a detection result of the power detection circuit 114, can generate a reset signal.

The microcomputer 100 has the following functions in addition to the above-described functions.

The interrupt controller (INT) 112 fetches an interrupt signal from the peripheral circuits (WDT 109, SCI 110, and A/D converter 122) and outputs an interrupt request signal to the CPU 103. The WDT 109 detects runaway of the CPU 103 and request for a reset.

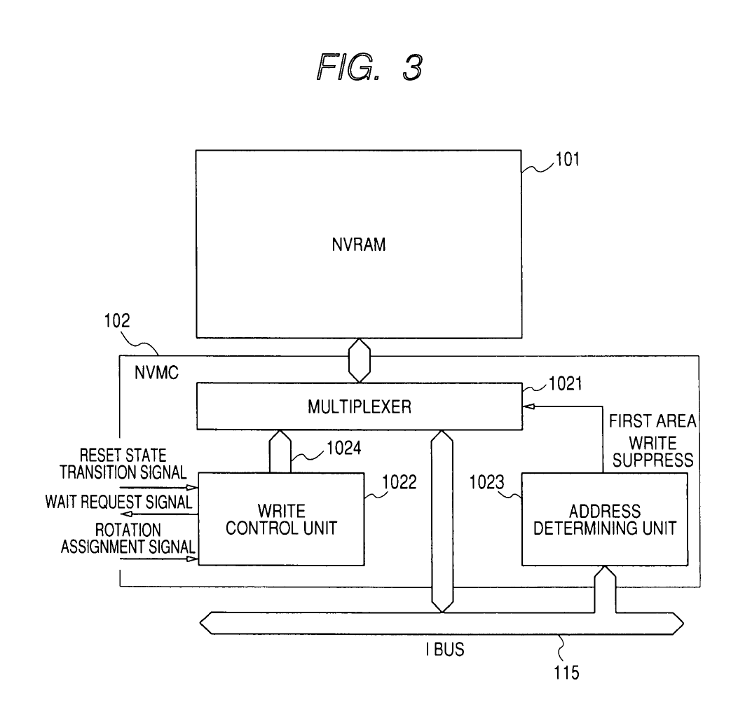

FIG. 3 shows a configuration example of the NVMC 102.

The NVMC 102 includes a multiplexer 1021, a write control unit 1022, and an address determining unit 1023. The write control unit 1022 generates a write control signal 1024 to a predetermined address after start of operation. The predetermined address may be in any of the unit of data of the CPU 103 such as one bit, plural bits, a byte, a word, or the like, a word line unit of the NVRAM 101, or higher. The write control signal 1024 includes an address, data, a write signal which are supplied to the NVRAM 101 via the multiplexer 1021. The write data is to invalid the nonvolatile retention in a part of the storage area of the NVRAM 101, and may be the logical value “0” or “1”, mixed data of “0” and “1”, or a predetermined arbitrary value which can be set by the user. The number of writing times may be designated from the outside of the NVMC 102. The designation may be fixed. The invention is not limited to the designation, and data may be always written in a part of the area. By setting the size of write data and the number of writing times, the size of the nonvolatile holding invalid area can be arbitrarily changed.

In a state where the NVMC 102 writes data to the NVRAM 101, a wait request is sent to the CPU 103 and the BSC 111. The multiplexer 102 selectively supplies the write control signal 1024 and the bus control signal of the I bus 115 to the NVRAM 101. In a period in which the writing control is performed by the write control unit 1022, the write control signal 1024 is selected by the multiplexer 1021. The address determining unit 1023 determines an address (the address of the CPU 103) input from the I bus 115. In the case where data is written in a first area which will be described later, the address determining unit 1023 supplies a first area write suppress signal to the multiplexer 1021 so as to suppress writing to the NVRAM 101.

In the case where the NVRAM 101 is divided into a plurality of modules and there is a module having no nonvolatile holding invalid area, the module in the NVRAM 101 can be coupled to the I bus 115 while bypassing the NVMC 102.

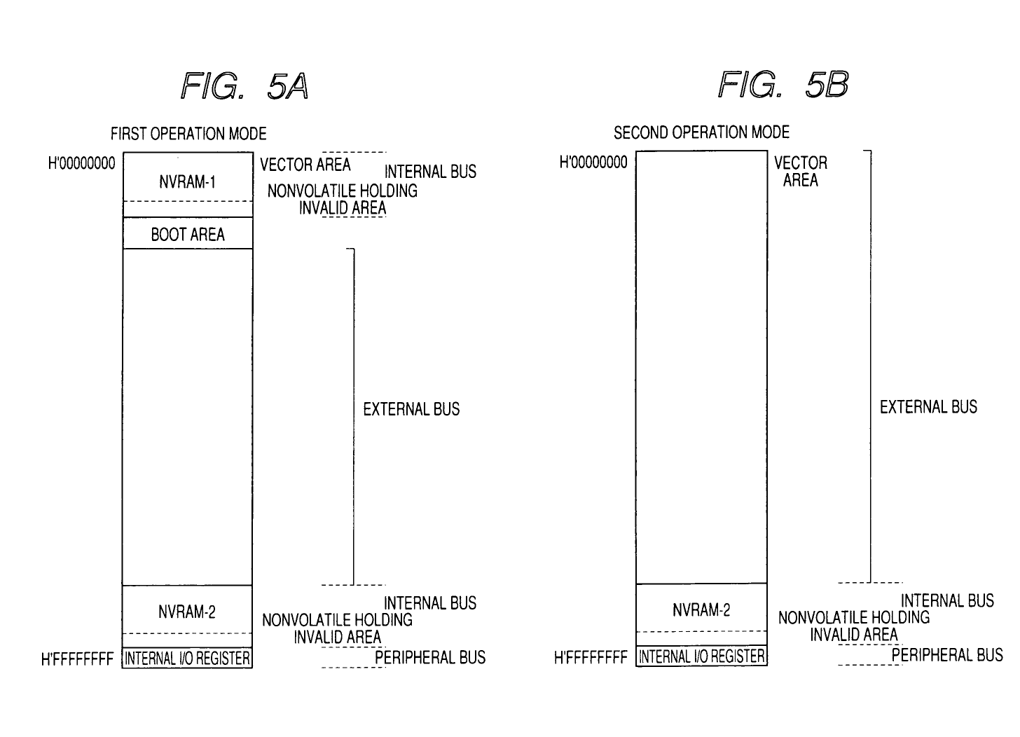

FIGS. 5A and 5B show an address space managed by the CPU 103.

Although not limited, the address space of the CPU 103 is made of 4G bytes. Each of the NVRAM 101 and the I/O register 121 in the microcomputer 100 operates with a unique address, bus width, and the number of access states. As described above, the NVRAM 101 is coupled to an internal bus (I bus 115) via the NVMC 102, and reading/writing operation is usually performed in one state. The NVRAM 101 is disposed in a plurality of addresses.

The CPU 103 includes a first operation mode and a second operation mode. In the first operation mode, for example, as shown in FIG. 5A, a first area NVRAM-1 is used mainly for programs, and a second area NVRAM-2 is used mainly for data. The first area NVRAM-1 includes an exception process vector of the CPU 103. It is sufficient to dispose the first and second areas NVRAM-1 and NVRAM-2 in accordance with an addressing mode of the CPU 103 or the like. Mainly, writing to the first area for programs is inhibited by the NVMC 102 in order to protect the programs. An area to be rewritten after start of operation (nonvolatile holding invalid area) is set so as not to overlap the exception process vector. In the case where the NVRAM 101 is divided into a plurality of modules, preferably, they are disposed in different modules. In the embodiment, the nonvolatile holding invalid area is formed in a part of the second area NVRAM-2. In the second operation mode, the first area NVRAM-1 is set in an external space as shown in FIG. 5B. In this case, the NVRAM 101 is used mainly as a data area, and a memory coupled to the external bus is used mainly for storing programs.

As shown in FIG. 5A, there is a case that an area (boot area) which stores a program for initially writing or rewriting (booting) a program and is not used for normal operation is provided. In the area, the nonvolatile holding invalid area is not provided. The area may be read only in a predetermined boot mode or the like. In the boot mode or at the time of execution of a program in the boot area, writing to the first area NVRAM-1 may be permitted.

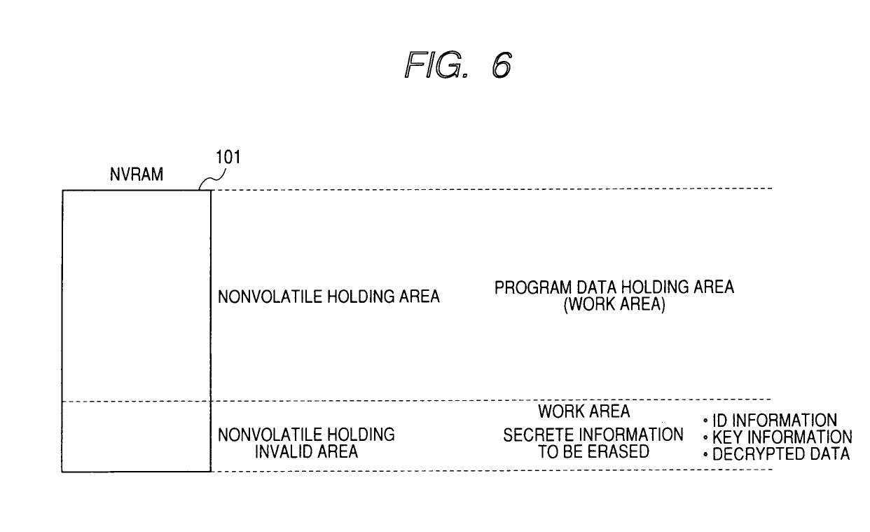

FIG. 6 shows an example of data stored in the NVRAM 101.

The NVRAM 101 can be read or written by a random access. Unlike a flash memory, it is unnecessary to perform a special operation such as erasing operation at the time of writing. Data can be written to the NVRAM 101 by execution of the program on the NVRAM 101. Consequently, a program area and a data area can be provided on the single NVRAM 101. The data area includes an area of data to be stored and an area of data which should not be held (data to be erased). For example, an area of data which should not be held (data to be erased) from the viewpoint of security is set as the nonvolatile holding invalid area. In the nonvolatile holding area except for the nonvolatile holding invalid area in the NVRAM 101, a program and data storing area can be provided. The nonvolatile holding invalid area is used as a work area of the CPU 103 and stores secret information which should not be held (data to be erased). Work data which is not secret may be stored in the nonvolatile holding area.

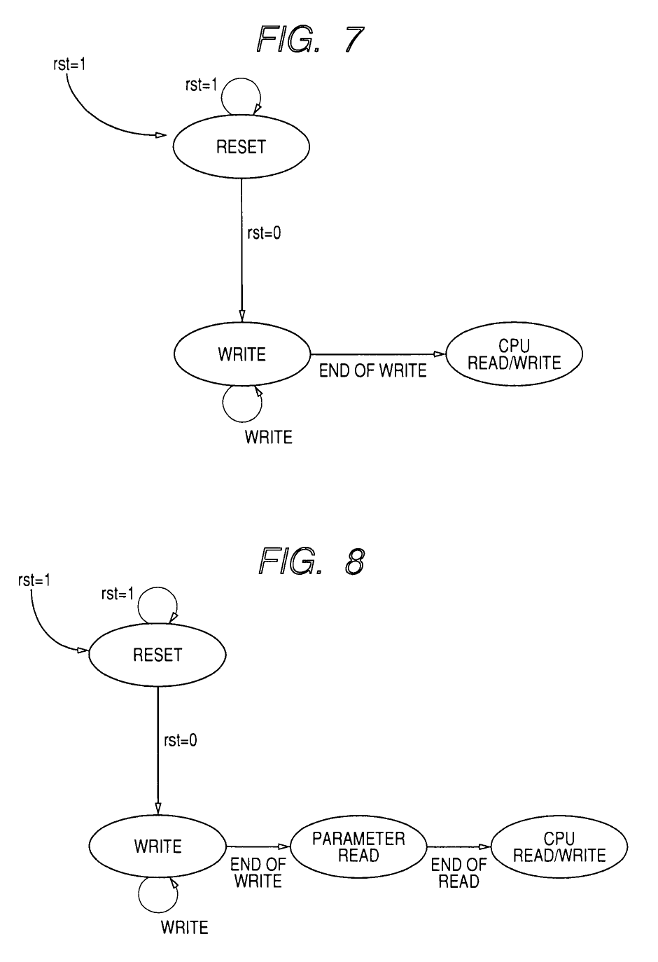

FIG. 7 shows state transition of the NVMC 102.

When a reset state transition signal rst from the RESC 113 is asserted to the logical value “1” by resetting of the microcomputer 100 or the like, the NVMC 102 shifts to a reset state. After the reset, the NVMC 102 shifts to a write state and, by the control of the write control unit 1022, a write cycle for a predetermined address in the nonvolatile holding invalid area is issued. Since data cannot be read/written from/to the NVRAM 101 from the CPU 103, in the case where the CPU 103 reads/writes data from/to the NVRAM 101, a wait signal is activated to request for a wait state. After completion of predetermined writing operation of the NVMC 102 (after transition to the CPU read/write state). The CPU 103 reads/writes data from/to the NVRAM 101. When the NVMC 102 is in a writing state, the reset of the CPU 103 may be continued. After completion of predetermined writing operation, the NVRAM 101 shifts to the read/write state of the CPU 103. In response to a predetermined write state (writing operation) after the reset, an invalidating process can be performed on the nonvolatile holding invalid area.

In the case where power-on is detected by the power detection circuit 114 in the RESC 113, the NVMC 102 may be changed to the reset state and, after completion of power-on or after lapse of predetermined time, the NVMC 102 may be changed to the write state. It is also possible to detect an abnormal state such as overflow of the WDP 109 or interruption which cannot be masked and make the NVMC 102 change to a reset state. In the case where the NVRAM 101 includes parameter information and the like, as shown in FIG. 8, a parameter reading state may be added after completion of the writing operation. Examples of the parameter information are trimming information of the NVRAM 101 and adjustment of an analog value of the A/D converter 122.

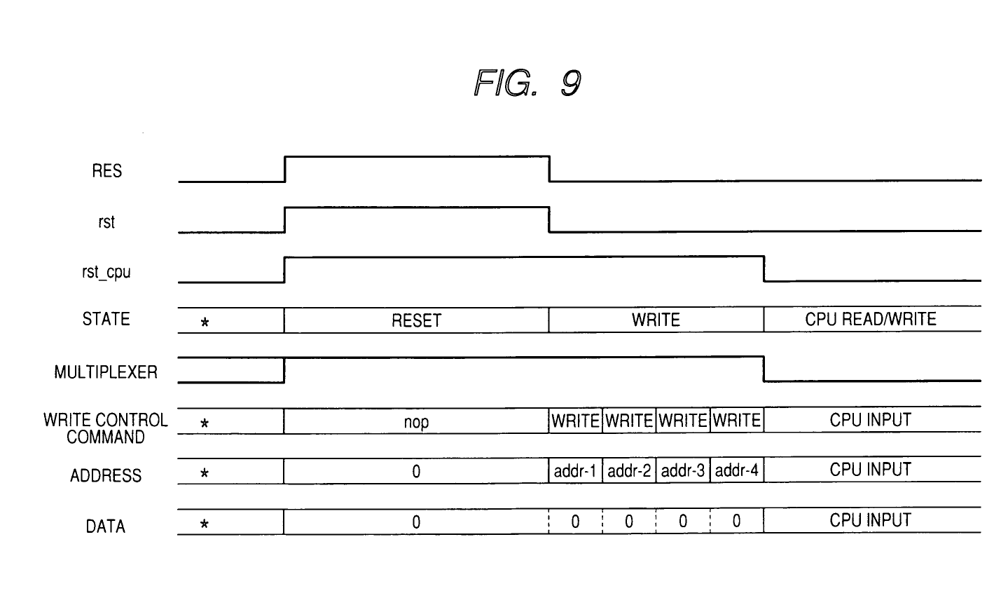

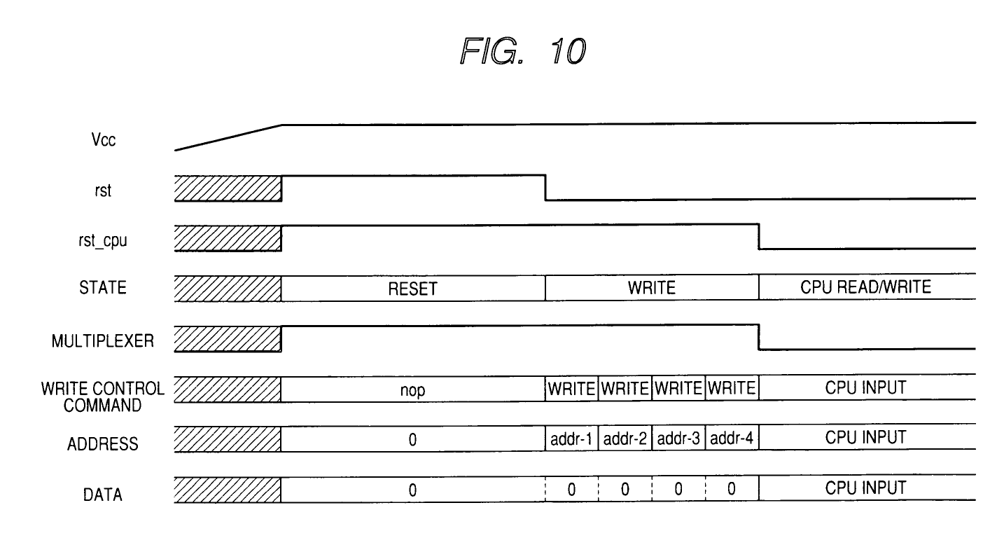

FIG. 9 shows operation timings of main parts in the microcomputer 100.

As shown in FIG. 9, when the reset state transition signal rst becomes the logical value “1” in accordance with the reset signal RES from the outside, the NVMC 102 shifts to the reset state. The selection of the multiplexer 1021 is switched to the write control unit 1022, and read/write commands from the CPU 103 are suppressed (nop). Consequently, addresses and data are initialized.

When the reset state transition signal rst becomes the logical value “0” and the reset is cancelled, a write state is obtained. Data is written to predetermined addresses (addr-1 to addr-4). In the example, the writing operation is successively performed four times. An address of such writing operation is generated by hardware in the write control unit 1022 so as to correspond to the nonvolatile holding invalid area in FIGS. 5A and 5B. The write data is, although not limited to the logical value “0”. After completion of the writing operation, the NVMC 102 shifts to the CPU read/write state, and the selection of the multiplexer 1021 is switched to the I bus 115. For a period corresponding to completion of the writing operation (in the example, time corresponding to the writing operations of four times), the RESC 113 activates a reset signal rst_cpu corresponding to the CPU 103. After that, the read/write commands from the CPU 103 are received.

FIG. 10 shows another example of operation timings of the main parts in the microcomputer 100.

When the power supply Vcc of the microcomputer 100 is turned on and the power detection circuit 114 detects that the power reaches a predetermined power voltage level, the reset state transition signal rst is set to the logical value “1”, and the NVMC 102 shifts to the reset state. The selection of the multiplexer 1021 is switched to the write control unit 1022, and read/write commands from the CPU 103 are suppressed (nop). When the reset state transition signal rst becomes the logical value “0” and the reset is cancelled, a write state is obtained. Data is written to predetermined addresses (addr-1 to addr-4). Since the subsequent operations are similar to those shown in FIG. 9, their description will not be repeated.

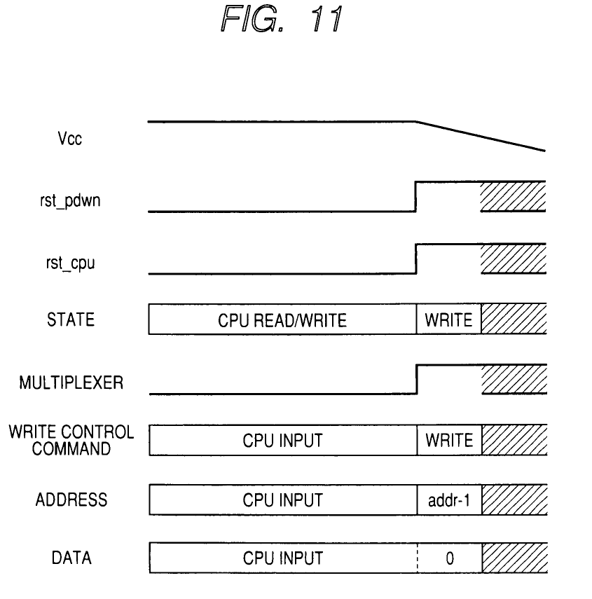

FIG. 11 shows another example of the operation timings of the main parts in the microcomputer 100.

When a level drop in the power voltage Vcco f the microcomputer 100 is detected, a reset signal rst_pdwn is set to the logical value “1”. The reset signal rst_pdwn is generated by the RESC 113 on the basis of the detection result of the power detection circuit 114. When the reset signal rst_pdwn is set to the logical value “1” and the write state is obtained, data is written to a predetermined address (addr-1). When the power supply voltage Vcc drops to the necessary minimum level or less, data cannot be written. Consequently, an area which can be written changes according to the degree of drop or retention of the voltage. The operation of the example is preferably combined with the operation of FIGS. 9 and 10. When writing operation is performed after power-on as shown in FIGS. 9 and 10, an area logically designated can be written reliably. Data can be written at least before start of the operation of the CPU 103.

In the case where the NVRAM 101 is divided into a plurality of modules and a nonvolatile holding invalid area and an exception process vector area are disposed in different modules, a reset signal rst_cpu for the CPU 103 is made similar to the reset state transition signal rst. When the CPU 103 accesses an area including the nonvolatile holding invalid area, a wait request is sent.

Operations can be similarly performed also in the case where the exception process vector area does not exist in the NVRAM 101 such as the second operation mode shown in FIG. 5B. After detection of the rising edge of the reset state transition signal rst, the write state may be set before the trailing edge of the reset state transition signal rst. In any case, it is sufficient to perform automatic rewriting before the CPU 103 accesses the NVRAM 101. Also in the case where the microcomputer 100 has a plurality of operation modes, the automatic rewriting is performed irrespective of the operation mode.

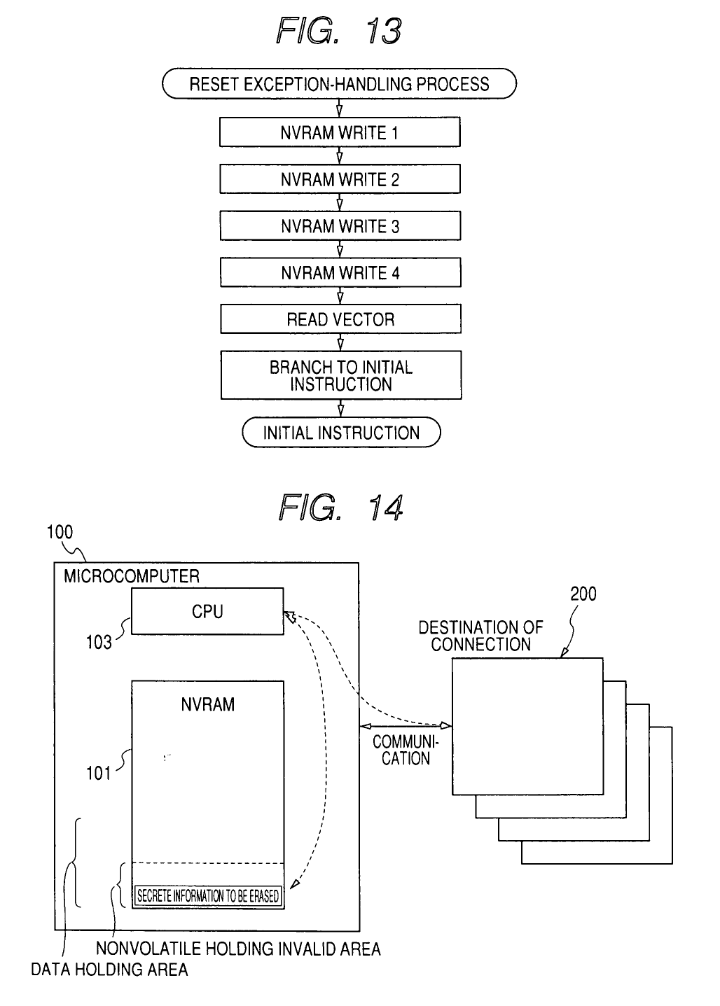

FIG. 13 shows a flowchart at the time of cancelling reset of the CPU 103.

When reset is cancelled, the CPU 103 performs reset exception-handling process.

In the reset exception-handling process, the CPU 103 performs steps of writing data to the nonvolatile holding invalid area (NVRAM write 1 to NVRAM write 4). That is, irrespective of the NVMC 102, the NVRAM 101 is automatically rewritten. The execution unit 105 of the CPU 103 is provided with logics for generating an address and data, that is, sectors for an address and data of a normal command execution, and the control unit 104 is provided with logics for controlling the selector, generation of a bus command, and controlling of the flow. Consequently, the CPU 103 reads an exception-handling vector and branches it to the head command of the program. The operation is similar to that in a normal CPU.

It is also possible to execute a program for automatic rewriting after the reset exception-handling process and branch the vector to the head command of an inherent program. Alternatively, a DMA controller or the like is provided. After resetting, the DMA controller is automatically activated and the nonvolatile holding invalid area may be written.

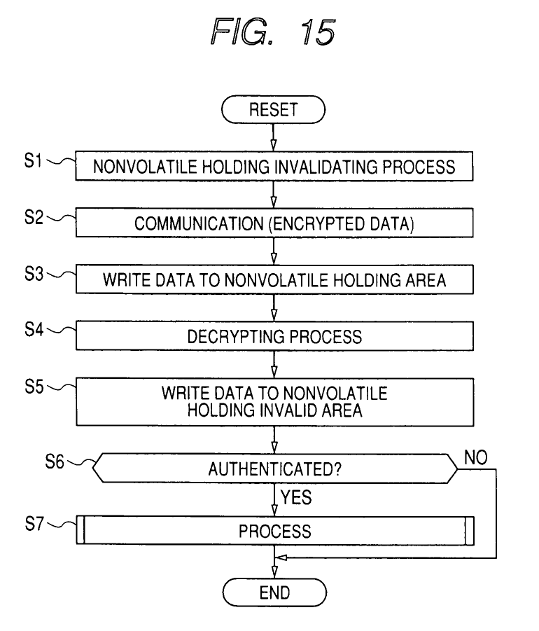

FIG. 14 shows an application example of the microcomputer 100. FIG. 15 shows a process flowchart in the application example of FIG. 14.

As shown in FIG. 14, the microcomputer 100 performs communication with another microcomputer 200 coupled to the microcomputer 100. The microcomputer 100 performs required operation in accordance with the communication. A part to be coupled varies. The communication information includes secret information such as ID information unique to the microcomputer to which the microcomputer 100 is coupled and key information. In some cases, the microcomputer 200 to which the microcomputer 100 is coupled is authenticated. Even when the secret information such as ID information and key information encrypted or the like is from the connection destination at the time of communication, decrypted data or data before the encryption exists in the microcomputer. When such data is held in the NVRAM 101, the possibility that the data is read by execution of a malicious program increases. Since the encryption is performed at the time of communication to keep the secret information, the secret information such as decrypted data in the microcomputer should be also prevented from being read. To prevent undesirable holding of such secret information, after completion of the required process, it can be considered to initialize or rewrite the secret information by a program in the microcomputer 100. However, for example, if the power is shut down maliciously before the data is initialized or rewritten, the initialization or rewriting may fail.

In such a use method, the microcomputer 100 initializes or rewrites the nonvolatile holding invalid area (nonvolatile holding invalidating process) after reset (S1). After that, the microcomputer 100 follows a program stored on the NVRAM 101 and, under control of the CPU 103, the ID information and key information of the microcomputer 200 to which the microcomputer 100 is coupled is input via the SCI 110 at the time of coupling (S2). The input data is once written in the NVRAM 101 and held. When the data is encrypted data, the data may be stored in the nonvolatile holding area in the NVRAM 101 (S3). Under control of the CPU 103, input data decrypting process or the like is performed in the encrypting function unit 106 (S4). To the encrypting function unit 106, key information and the like is properly supplied. The ID information, key information, and decrypted data (plain text) is stored (written) in the nonvolatile holding invalid area at an arbitrary timing as necessary, and malicious reading is suppressed (S5).

On the contrary, in the case of encrypting data, original data (plain text) is stored in the nonvolatile holding invalid area. Encrypted data may be stored in the nonvolatile holding area. Also in the case where the encryption function processes data, a plain text is stored in the nonvolatile holding invalid area and a cipher can be stored in the nonvolatile holding area. The decrypted data is referred to (read/written) during the operation of the CPU 103 such as authentication (S6). After the authentication is made, a process necessary for the system is performed (S7). When the authentication is not made, the routine is finished without performing the process.

When the microcomputer 200 to which the microcomputer 100 is coupled is decoupled, it is unnecessary to hold the secret information such as the ID information and key information unique to the microcomputer 200. In the case of connecting the microcomputer 100 to another microcomputer, the ID information and key information of the another microcomputer is input to the nonvolatile holding invalid area and similar processes are performed.

In the microcomputer 100, when the secret information which should not be held (information to be erased) such as the ID information, key information, and decrypted data is stored in the nonvolatile holding invalid area, the work of initializing or rewriting the secret information by the program in the microcomputer 100 as described above is unnecessary. Even in the case where the power is maliciously shut down during operation, since the information is rewritten at the next power-on of the operation of the microcomputer 100, the information cannot be read even without bad intention. Thus, security can be enhanced.

By the foregoing embodiments, the following effects can be obtained.

(1) By using the NVRAM 101 to/from which data can be written/read by a random access as a program area and a work data area in the CPU 103, the hardware resources can be saved, and it can contribute to simplification of the manufacturing process, so that the manufacture cost can be reduced. Since a general RAM is not mounted in addition to the NVRAM 101, it is unnecessary to consider current for holding stored data in the RAM and to take a countermeasure against a soft error. In this case, an area where nonvolatile holding is invalid is provided in a part of the storage area of the NVRAM 101. By using the area for storing secret data to be held, the secret data to be held is prevented from being nonvolatile-held in the NVRAM 101. Thus, the security in the case where a nonvolatile memory device (NVRAM) which can be read/written by a random access is mounted as a memory for program and data can be improved.

(2) By performing automatic rewriting (the process of invalidating the nonvolatile holding invalid area) in the NVMC 102, the existing CPU 103 can be used. Even in a test mode or the like of stopping the CPU 103 and reading/writing the NVRAM 101 and the other modules from the outside, the automatic rewriting can be performed.

(3) By holding the CPU 103 in a reset state during automatic rewriting of the NVMC 102, the internal state of the microcomputer 100 can be simplified.

(4) In the case where the exception process vector area exists out of the NVRAM 101 including the nonvolatile holding invalid area, the CPU 103 is operated also in the automatic rewriting operation. By issuing a wait request when the NVRAM 101 being automatically rewritten is accessed, undesired wait time can be suppressed.

(5) By performing the automatic rewriting by the CPU 103, the NVMC 102 can be made unnecessary.

(6) By prohibiting writing of the area used for a program in the NVRAM 102, different from a flash memory or the like, undesired rewriting of a program caused by easy rewriting can be suppressed.

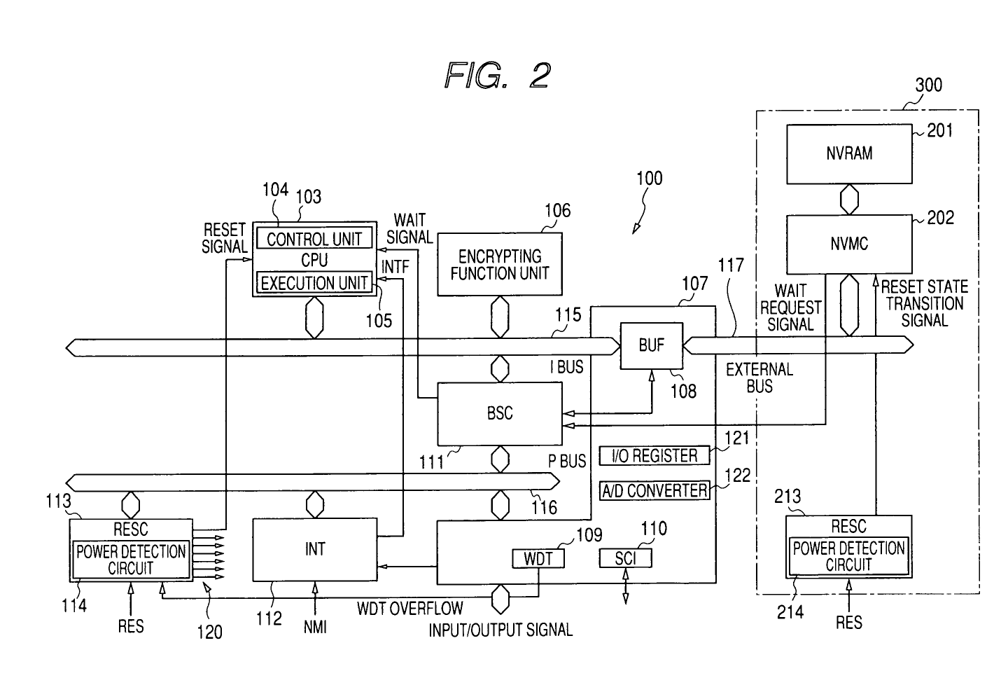

FIG. 2 shows another configuration example of the main parts of the microcomputer 100.

The microcomputer 100 shown in FIG. 2 is constructed by two semiconductor chips. The microcomputer 100 shown in FIG. 2 is largely different from that in FIG. 1 with respect to the point that an NVRAM 201 and an NVMC 202 corresponding to the NVRAM 101 and the NVMC 102, respectively, are formed on a chip 300 different from the CPU 103. In the chip 300, a RESC 213 including a power detection circuit 214 capable of detecting a power voltage in the chip 300 is provided. The NVMC 202 is reset by a reset state transition signal generated by the RESC 214. The NVMC 202 is coupled to the I bus 115 via the external bus 117 and the BUF 108. The functions of the NVRAM 201, NVMC 202, and RESC 213 are similar to those of the NVRAM 201, NVMC 202, and RESC 113, respectively, shown in FIG. 1, so that their detailed description will not be repeated. In the case where the microcomputer system 100 is constructed by a plurality of semiconductor chips, effects similar to those of the case shown in FIG. 1 can be obtained.

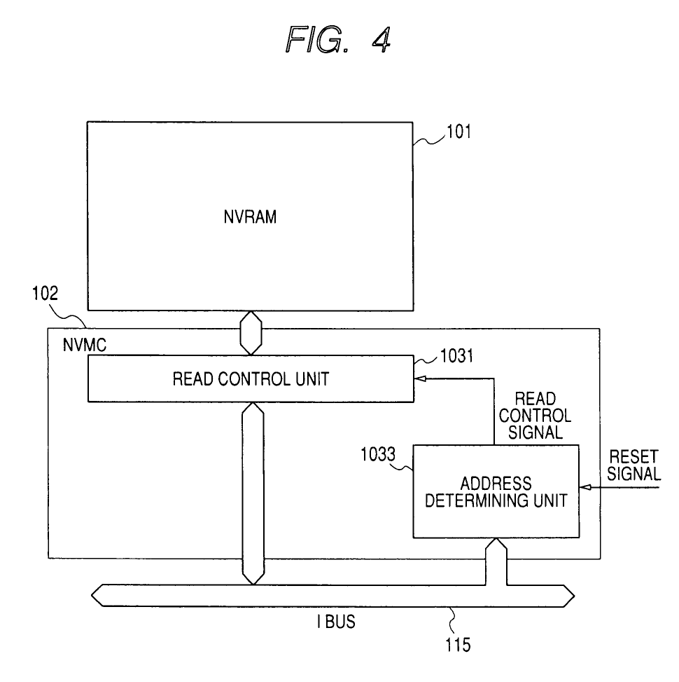

FIG. 4 shows another configuration example of the NVMC 102.

The NVMC 102 includes an address determining unit 1033 and a read control unit 1031. The address determining unit 1033 enters a read preventing state by reset after operation start. In this state, according to an address determination result, reading of areas other than the nonvolatile holding invalid area is permitted. The reading operation on the nonvolatile holding invalid area is inhibited. The writing operation is permitted irrespective of the areas. Further, writing to the nonvolatile holding invalid area is observed. It is determined that data has been written in all of addresses in the nonvolatile holding invalid area, and the address determining unit 1033 enters a read permission state. In this state, reading is permitted irrespective of the areas. The read control unit 1031 is permitted/inhibited to read the NVRAM 101 in accordance with the read permission/inhibition of address determination. Since the nonvolatile holding invalid area cannot be read until data is written, data before the operation start can be prevented from being read. As data which is written can be read, there is no inconvenience to use the area as a work area. The reading operation may be inhibited by interrupting a read signal to the NVRAM 101 or masking read data.

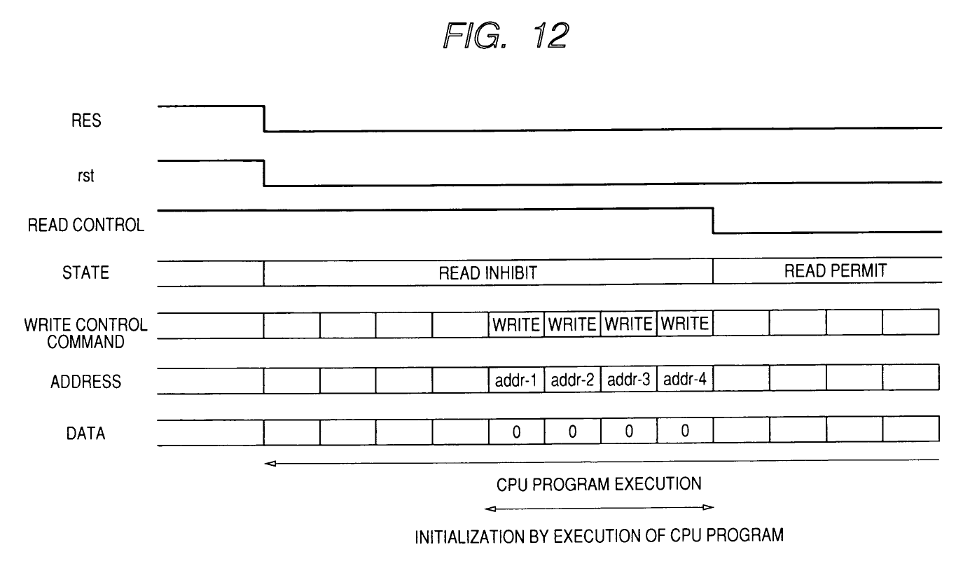

FIG. 12 shows operation timings of the microcomputer 100 in the case of employing the configuration illustrated in FIG. 4.

When the reset state transition signal rst comes to have the logical value “1”, the NVMC 102 is shifted to the read preventing state. When the writing of data to the predetermined addresses (addr-1 to addr-4) by the CPU 103 is detected, the NVMC 102 is shifted to the read permission state. In the example, the NVMC 102 is shifted to the read permission state after four times of writing operations. It is also possible to permit reading of data from the address every writing operation.

By inhibiting the reading, the execution of a program of the CPU 103 after reset can start early. In the case where the work area is initialized by executing a program, data is not written twice in the same address or in an address which is not used.

The present invention achieved by the inventors herein has been concretely described, obviously, the invention is not limited to the above description but can be variously modified without departing from the gist of the invention.

For example, the NVRAM 101 is not limited to an MRAM. As long as the NVRAM 101 can be accessed for writing at random and can hold data in a nonvolatile manner, it is sufficient. The NVRAM 101 can be constructed arbitrarily. For example, a plurality of NVRAMs 101 for programs and for data may be provided. It is desirable to use the NVRAMs 101 of the same kind for programs and for data. The NVRAM 101 and the NVMC 102 may be integrally formed. It is sufficient to have functions corresponding to a memory array and an NVMC. The NVRAM may have data and a syndrome so that an error can be corrected with an ECC (Error-Correcting Code).

The read inhibiting means can be also constructed arbitrarily. It is sufficient to provide means which cannot read data written before operation start but can read data written after the operation start.

As data for automatic rewriting (the process of invalidating the nonvolatile holding invalid area), arbitrary data can be used. It is sufficient not to hold old data. As the data for automatic rewriting, a fixed value or a random value may be used. The nonvolatile holding invalidation denotes operation of disabling reading of data already stored before the operation start, and is not limited to reset the state of a storing device to a writable state like in a flash memory. The nonvolatile holding invalidating operation can be performed. Address allocation and an address range for automatic rewriting can be also arbitrarily set. With respect to the address range for automatic rewriting, as employed in the flash memory as well, batch writing can be performed on the block unit basis.

Further, the address range for automatic rewriting may be set in a manner different from that in a write sequence performed by executing the program of the CPU 103. For example, in place of writing a byte area corresponding to an address, only data of bit “0” may be written to eight addresses for the reason that data having meaning on a byte unit basis looses the meaning when even one bit of the data is rewritten. In the case of performing error correction with the ECC, only a syndrome may be written.

The invention is not also limited to the configuration of the microcomputer and the size and arrangement of the address space. The other function blocks and the like can be also variously changed. In addition to the CPU 103 and the encrypting function unit 106, a module enabling data to be written on the NVRAM 101 such as the DMA controller may be mounted.

The other party of communication with the microcomputer 100 is not limited to the microcomputer. Data to be transmitted is not limited to the ID information and key information but may be an arbitrary literary work or the like. Data to be stored in the nonvolatile holding invalidating area is not limited to the ID information and key information but may be any of secret information generated or decrypted in the microcomputer.

Although the present invention achieved by the inventors herein has been described with respect to the case where it is applied to a single-chip microcomputer as in the field of utilization in the background of the invention, the invention is not limited to the single-chip microcomputer but can be widely applied to a microcomputer including a nonvolatile memory device which can be accessed at random.

What is claimed is:

1. A microcomputer comprising:
a CPU enabling a computing process based on a preset program; and
a nonvolatile memory device which can be read/written by random access of the CPU,
wherein the nonvolatile memory device includes, in a part of its memory area, an area in which nonvolatile holding is invalid.

2. The microcomputer according to claim 1, wherein information stored in the nonvolatile memory device can be rewritten without a preliminary erasing process at the time of the writing operation.

3. The microcomputer according to claim 1, further comprising a power detector capable of detecting a power voltage level,
wherein after power-on, operation of the nonvolatile memory device is started on the basis of a detection result of the power detector.

4. The microcomputer according to claim 1, further comprising an operation monitor for monitoring operation of the CPU,
wherein the operation of the nonvolatile memory device is started on the basis of a result of monitoring in the operation monitor.

5. The microcomputer according to claim 1,
wherein the nonvolatile memory device includes: a program area capable of storing a program to be executed by the CPU; and a data area capable of storing data used in the execution of the program in the CPU,
wherein by execution of the program in the CPU, data writing to the data area is enabled, and
wherein, after invalidating nonvolatile holding in at least a part of the memory area in the nonvolatile memory device, reading operation of the CPU is permitted.

6. The microcomputer according to claim 1, wherein the operation of invalidating nonvolatile holding in at least a part of the memory area in the nonvolatile memory device is an operation of writing data to the nonvolatile memory device.

7. The microcomputer according to claim 1,
wherein the nonvolatile memory device includes: a program area capable of storing a program to be executed by the CPU; and a data area capable of storing data used in the execution of the program in the CPU,
wherein by execution of the program in the CPU, data writing to the data area is enabled, and
wherein, after writing data to the data area by the CPU, reading of the data area is permitted.

8. The microcomputer according to claim 1,
wherein the nonvolatile memory device is disposed in each of a first address area and a second address area managed by the CPU,
wherein only reading of the nonvolatile memory device is allowed from the first address area, and
wherein reading and writing of the nonvolatile memory device are allowed from the second address area.

9. The microcomputer according to claim 1, wherein secret data to be held is stored in the area in which nonvolatile holding is invalid in the nonvolatile memory device.

10. The microcomputer according to claim 1, wherein original data to be encrypted, decrypted data, or information for encryption or decryption is stored in the area in which nonvolatile holding is invalid in the nonvolatile memory device.

11. The microcomputer according to claim 6, wherein writing operation for invalidating nonvolatile holding in at least a part of the memory area in the nonvolatile memory device is performed separately from writing operation performed by executing a program in the CPU.

12. A microcomputer comprising:
a CPU enabling a computing process based on a preset program;
a nonvolatile memory device which can be read/written by random access of the CPU; and
a memory controller for invalidating nonvolatile holding in a part of a memory area in the nonvolatile memory device at the time of at least one of operation start and power shutdown of the nonvolatile memory device.

13. The microcomputer according to claim 12, wherein information stored in the nonvolatile memory device can be rewritten without a preliminary erasing process at the time of the writing operation.

14. The microcomputer according to claim 12, further comprising a reset controller capable of generating a reset signal for resetting the CPU and the nonvolatile memory device to an initial state and to start operation,
wherein the reset controller includes a power detector for detecting level of power voltage supplied to the microcomputer, and generates the reset signal on the basis of a result of detection in the power detector.

15. The microcomputer according to claim 12, further comprising a reset controller capable of generating a reset signal for resetting the nonvolatile memory device to an initial state and to start operation, and an operation monitor capable of monitoring operation of the CPU,
wherein the reset controller generates the reset signal on the basis of a result of monitoring in the operation monitor.

16. The microcomputer according to claim 12,
wherein the nonvolatile memory device includes: a program area capable of storing a program to be executed by the CPU; and a data area capable of storing data used in the execution of the program in the CPU,
wherein by execution of the program in the CPU, data writing to the data area is enabled, and
wherein, after invalidating nonvolatile holding in at least a part of the memory area in the nonvolatile memory device, reading operation of the CPU is permitted.

17. The microcomputer according to claim 12,
wherein the nonvolatile memory device includes: a program area capable of storing a program to be executed by the CPU; and a data area capable of storing data used in the execution of the program in the CPU, and
wherein, after data is written to the data area by the CPU, operation of reading the data area is permitted.

18. The microcomputer according to claim 12, wherein an area in which nonvolatile holding is invalid in the nonvolatile memory device is a work area which does not include an exception process vector of the CPU.

19. The microcomputer according to claim 12, wherein the CPU stores secret data to be held in the area in which nonvolatile holding is invalid in the nonvolatile memory device.

20. The microcomputer according to claim 12, wherein the memory controller includes: a write control unit for generating a signal for making nonvolatile holding invalid; and a multiplexer for selecting a signal for making the nonvolatile holding invalid and a signal for reading or writing of the CPU.

21. The microcomputer according to claim 12, wherein the memory controller includes a write control unit for performing a writing operation for invalidating nonvolatile holding in at least a part of the memory area in the nonvolatile memory device separately from writing operation performed by the CPU.

22. A microcomputer comprising:
a CPU enabling a computing process based on a preset program; and
a nonvolatile memory device which can be read/written by random access of the CPU,
wherein the nonvolatile memory device includes: a program area capable of storing a program to be executed by the CPU; and a data area capable of storing data used in the execution of the program in the CPU,
wherein the data area includes: a first memory area in which nonvolatile holding is valid; and a second memory area in which nonvolatile holding is invalid, and
wherein the CPU uses the second memory area as a work area.

23. The microcomputer according to claim 22, wherein operation of writing or rewriting the area in which nonvolatile holding is invalid in the nonvolatile memory device is performed at the time of at least one of operation start and power shutdown of the nonvolatile memory device.

24. The microcomputer according to claim 22, wherein reading from the nonvolatile memory device is interrupted until the area in which nonvolatile holding is invalid in the nonvolatile memory device is written or rewritten.
